(19) United States
(12) Patent Application Publication
(10) Pub. No.: US 2003/0043209 A1
(43) Pub. Date: Mar. 6, 2003

(54) Directional shadowing user interface

(76) Inventor: Douglas J. Pearson, Seattle, WA (US)

Correspondence Address: HEWLETT-PACKARD COMPANY, Intellectual Property Administration, P. O. Box 272400, Fort Collins, CO, 80527-2400, US

(21) Appl. No.: 09/944,679

(22) Filed: Aug. 31, 2001

(51) Int. Cl. G09G 5/00

(52) U.S. Cl. 345/835

(57) ABSTRACT

Systems, methods and computer-executable instructions therefore are described herein for a user interface for user selection of directional shadows applied to rendered objects.

### FIELD OF THE INVENTION

The present invention relates to a user interface, and more particularly to a user interface for controlling the direction of the shadowing of printed characters.

### BACKGROUND OF THE INVENTION

Visual cues provide enhanced perception of realism in printed graphics. One such visual cue is the casting of shadows from objects that are within the path of light coming from a directional light source. Other visual cues with respect to shadowing include the length and direction that shadows are cast from objects. In addition to realistic renderings, shadowing provides the viewer with a perception as to the position of a directional light source with respect to the objects from which shadows are being cast. Shadows can provide aesthetics to the appearance of characters and objects in rendered documents, such as text. The appearance of shadows cause rendered text to have depth and three-dimensional aspects.

Printing programs associated with personal computers, and particularly word processing applications, allow a user to make a selection to have shadowing applied to text in a document. These software applications, however, do not allow the user any variation in the direction of the shadowing, and thus fail to provide the foregoing benefits of perceptual and aesthetic realism.

### SUMMARY OF THE INVENTION

In one embodiment, a user interface allows a user to select the direction of shadows applied to rendered objects.

These and other features of the present invention will become more fully apparent from the following description and appended claims, or may be learned by the practice of the invention as set forth hereinafter.

### DESCRIPTION OF THE DRAWINGS

To further clarify the above and other advantages and features of the present invention, a more particular description of the invention will be rendered by reference to specific embodiments thereof which are illustrated in the appended drawings. The same numbers are used throughout the drawings to reference like features and components. It is appreciated that these drawings depict only typical embodiments of the invention and are therefore not to be considered limiting of its scope. The invention will be described and explained with additional specificity and detail through the use of the accompanying drawings in which:

FIG. 1 illustrates a host computer having local access to a printer and in a system environment suitable for providing remote access to a plurality of printer network resources.

FIG. 2 is a block diagram illustrating a host computer in a system such as that shown in FIG. 1.

FIG. 3 illustrates an example of a menu for displaying on a display device that is in electrical communication with the host computer seen in FIG. 1.

FIG. 4 is a flow diagram illustrating an example of a method of displaying and activating a printer-shadowing menu on a display device that is in electrical communication with the host computer seen in FIG. 1.

### DETAILED DESCRIPTION

The user interfaces, systems, methods, and computer-executable instructions described herein relate to the presentation of a menu for specification and actuation of directional shadowing and related tasks for object and images, including text in a document. The directionally shadowed objects and images are first rendered upon a display terminal in electrical communication with a host computer, and then can be rendered as output documents on other display devices, such as printers, where access thereto can be local, remote, or both.

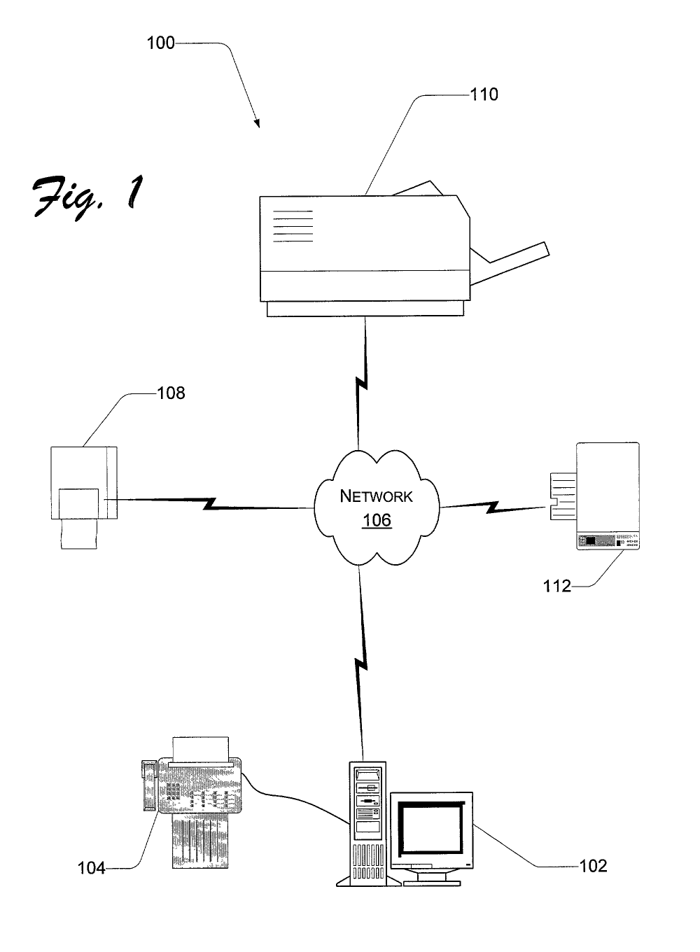

FIG. 1 illustrates an example of a system environment 100 suitable for implementing a display of a menu on a display device associated with a host computer 102 that provides a user with a choice as to the direction of shadowing that is applied to characters and other objects that are printed by a printer. The system environment 100 provides host computer 102 with local access to a multifunction peripheral (MFP) 104, sometimes referred to as an “All-In-One”. MFP 104 can function as a printer to print out characters and images that are transmitted from host computer 102. MFP 104 also has the capabilities of reading a stack of image-bearing paper with its sheet fed scanner, writing a duplicate of the scanned images with its printer function (e.g. copying), or sending a duplicate of the scanned pages with its facsimile transmission function over a telephone system (not shown). While host computer 102 is shown to be in local communication with MFP 104, it is also contemplated that host computer 102 could be in local communication with a standard printer, instead of MFP 104, that has less than all of the functionality of MFP 104.

The system 100 of FIG. 1 illustrates host computer 102 as being coupled to a plurality of printer network resources 108-112 through a network connection 106 that can include LANs (local area networks), WANs (wide area networks), an intranet, the Internet, or any other suitable communication link.

In general, the host computer 102 outputs host data locally to MFP 104 in a driver format suitable for the MFP 104, such as PCL or postscript for the printer function of MFP 104. MFP 104 converts the host data and outputs it onto an appropriate print media, such as paper, transparencies or glossy photo paper.

Host computer can also output host data remotely to printer network resources 108-112 through network connection 106. The printer network resources seen in FIG. 1 include a plotter 108, a black and white desktop laser printer 110, and a thermal ink jet color printer 112. In addition to printers that output characters and images that can be shadowed, the present disclosure also contemplates other types of devices that output characters and images that can be shadowed, including video display projectors, photo imaging substrate recorders, magnetic storage devices such as tape drives, diskette drives, and magneto optical read and write devices for reading and writing compact disks. Host computer 102 can actuate the output of characters and images that can be shadowed as renderings on any of the foregoing, as well as on printer network resources 108-112 seen in FIG. 1. As such, MFP 104 and printer network resources 108-112 illustrated in FIG. 1 are intended to represent these other types of devices that output characters and images that can be shadowed.

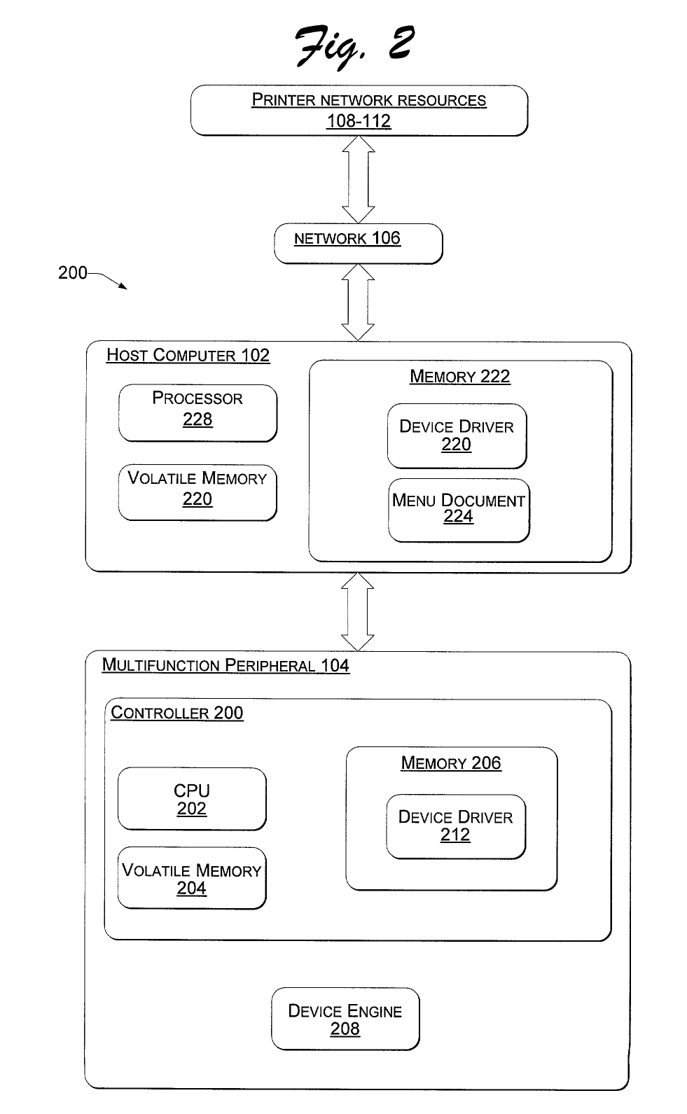

FIG. 2 illustrates an embodiment of the system 100 of FIG. 1 in greater detail. Host computer 102 includes a processor 228, a volatile memory 220 (i.e., RAM), and a non-volatile memory 222 (e.g., ROM, hard disk, floppy disk, CD-ROM, etc.). The host computer 102 may be implemented, for example, as a general-purpose computer, such as a desktop personal computer, a laptop, a server, and the like. The host computer 102 may implement one or more software-based device drivers 220 that are stored in non-volatile memory 222 and executed on the processor 228 to configure data into an appropriate format (e.g., PCL, postscript, etc.) and output the formatted data to MFP 104. Non-volatile memory 222 may also include a software application such as a word processing application that launches a printing function. A device driver 220 and a menu document 224 area in volatile memory 222 can be used to store the respective operational parameters of MFP 104 and of each of the printer network resources 108-112 that a user can select using a user interface that is displayed upon a display screen for the displayer terminal in communication with host computer 102.

The multifunction peripheral (MFP) 104 has a device controller 200 that processes the host computer 102 data. The controller 200 typically includes a data processing unit or CPU 202, a volatile memory 204 (i.e., RAM), and a non-volatile memory 206 (e.g., ROM, Flash). The device controller 200 processes host data and manages device functions by controlling the device engine 208. Controller 200 includes device driver software 212 stored in memory 206 and executed on CPU(s) 202. Within system 100 of FIG. 1, the MFP 104 is accessible locally by host computer 102 executing an application. A connection to network 106 is seen in FIG. 2 between host computer 102 and printer network resources 108-112. As such, host computer 102 can actuate printing functions, including the output of characters and images that can be shadowed, remotely, on any of printer network resources 108-112.

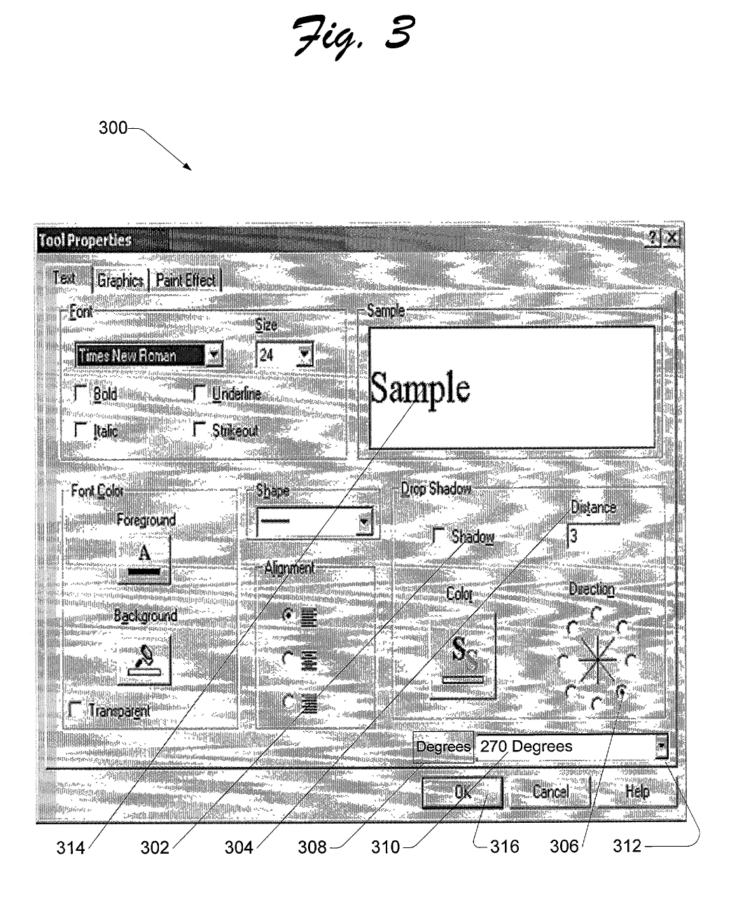

FIG. 3 illustrates an example menu page 300 that might be displayed on the display screen of host computer 102 of FIGS. 1-2. The menu page 300 is displayed when a software application initiates a printer function that is directed to MFP 104 or to any of printer network resources 108-112. Such a printer function could be initiated from a word processor software application, such as Microsoft WORD® or COREL WORD PERFECT®, for the purpose of obtaining a demand print out of the document created by the word processing software application.

In the illustrated implementation, menu page 300 has a dialog box that allows the user to select a particular type of shadowing that will be applied to characters and images that are to be printed. Of course, different menu page designs are contemplated that would rearrange the appearance of the selectable functions disclosed herein. A selection of the shadowing option can be made by keying in a check mark into a radio button 302. In a Microsoft WINDOWS® operating system environment, such a selection can be made by a “point-and-click” mouse function.

After radio button 302 has been checked, other input can be made within the shadowing dialog box. At input field 304, a user can key in the length of the shadows to be printed for characters and other images to be printed. A series of directional radio buttons 306, each corresponding to one of eight (8) compass points (e.g. N, S, E, W, NE, SE, SW, NW), allows the user to specify one compass point for the direction of shadows to be applied to printed characters and other images (e.g. shadowing features).

As an alternative to directional radio buttons 306, a dialog box 308 offers an input field 310 into which a user can key in a numeral representation of a particular direction for shadowing. Input field 310 will preferably allow a user to key in alternatives for specifying directional input, such as radians, or degrees, minutes, and seconds, or both. Alternatively, a pull down menu 312 can be actuated to offer to the user a variety of directional sections, in degrees or radians, for shadowing.

A sample of the result to the user's directional shadowing selections is displayed in Sample Box 314. As the user makes or changes selections, changes are also made to the appearance of the text seen in Sample Box 314. As such, the characters of the text being created using a word processor software application can be readily judged by a user for aesthetics and perceptual realism. Thus, Sample Box 314 illustrates the appearance of text that will be printed in a document when the user initiates a demand report of the document. A user can change selected directional shadowing selections 302-312 and review the results thereof as provided in Sample Box 314 until the user is satisfied that the demand report will be as desired.

In one implementation, a rendered shadow can be “pulled” for a predetermined object rendered in Sample Box 314. By way of example in a Microsoft Windows® operating system environment, when a user uses a pointing device such as a mouse to click and drag from a point within Sample Box 314, a shadow will be rendered as being cast from the predetermined object rendered in Sample Box 314. The direction and length of the shadow that is rendered is a function of the direction and length that the user drags the pointing device. After each such click-and-drag sequence, the resulting shadow is rendered in Sample Box 314. The user can try several different shadow appearances by a respective number of click-and-drag sequences to determine the best length and direction for the appearance of shadowing. In this implementation, a shadow is not rendered unless the user clicks and drags a point within Sample Box 314.

In another implementation, the user interface can include a dial control, where the user clicks or moves the mouse around the circle of a rotary dial in order to indicate the direction of the shadow rendering. Once the direction of the shadow has been input using the dial input, the length of the shadow can also be selected at input field 304. By way of example, the appearance of a dial on the user interface can be similar to the dial piece on a common rotary dial telephone.

Once all of the shadowing parameters have been selected for each menu item upon user interface menu 300, the user then actuates the shadowed printing function by pointing and clicking upon menu selection 316 seen in FIG. 3 with the label “OK”. The result of this actuation of menu selection 316 will be the actuation of the MFP 104 or other selected printer network resources 308-312 to commence the selected shadowed printing function.

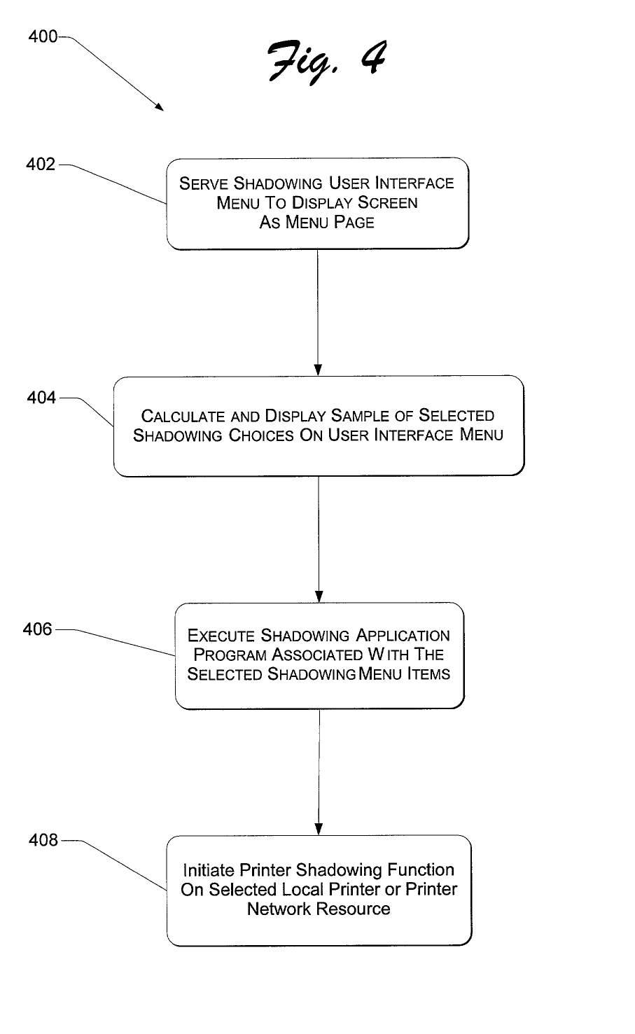

Example methods for implementing a directional shadowing actuation user interface menu screen will now be described with primary reference to FIG. 4. The methods apply generally to MFP 104 and to printer network resources 108-112 of FIGS. 1-2. FIG. 4 is a flow diagram 400 that shows an example of a general method for displaying a directional shadowing actuation user interface menu and activating a menu item thereon that is displayed upon a display device of host computer 102. At block 402, host computer 102 serves up a directional shadowing user interface menu for display upon the display device of host computer 102, such as upon a video display terminal or a cathode ray tube. Block 402 will preferably be executed upon the prior selection by a user of host computer 102 to perform a function using MFP 104 or using printer network resources 108-112, such as printing or ‘faxing’, and preferably from within a word processing software application.

At block 404 the host computer 102 receives the user's menu selections of various directional-shadowing options as discussed with respect to FIG. 3. When so received, host computer 102 calculates a sample of the selected shadowing choices that were input by the user on user interface menu 300 and displays a predetermined sample of the selected shadowing in Sample Box 314.

At block 406 the task execution instructions for the user shadowing selections are transmitted locally to MFP 104, or are transmitted remotely to printer network resources 108-112 through network connect 106 seen in FIGS. 1-2. Prior to block 406 being executed, the user points and clicks upon menu selection 316 seen in FIG. 3 with the label “OK”. At block 408, the printing of shadowed characters and images is performed at the selected printer according to the user's shadowing selections that were provided by the user through the user's use of the user interface display screen of FIG. 3.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A user interface comprising an actuatable icon representing a shadow direction for an object to be rendered that when actuated actuates the rendering of a shadow having the shadow direction from the rendered object.

2. The user interface as defined in claim 1, further comprising an actuatable icon representing a shadow length for the rendered shadow that when actuated actuates the rendered shadow having the shadow length.

3. The user interface as defined in claim 1, wherein the actuatable icon is a menu item on a menu.

4. The user interface as defined in claim 3, wherein the menu item is a numerical expression.

5. The user interface as defined in claim 4, wherein the numerical expression is selected from the group consisting of degrees and radians.

6. The user interface as defined in claim 3, wherein the menu item is a compass point direction.

7. The user interface as defined in claim 3, wherein the rendered object having the shadow direction is rendered upon the menu.

8. The user interface as defined in claim 7, further comprising a print actuation icon that when actuated actuates the printing of shadowed objects having the shadow direction.

9. The user interface as defined in claim 8, wherein a word processor software application actuates the display of the menu.

10. The user interface as defined in claim 7, wherein the printing operation is selected from the group consisting of printing, magnetic tape recording, photo imaging substrate recording, and magneto optical storage device writing.

11. In a word processor software application, a user interface for actuating demand printing and for displaying a menu having a plurality of menu items, the user interface comprising:
a predetermined object that is rendered on the menu; and
an actuatable icon displayed on the menu as one said menu item and representing a direction for rendering a shadow as being cast from the rendering of the predetermined object, wherein upon actuation of the actuatable icon the shadow is rendered upon the menu, having an appearance of being cast from the rendered predetermined object, and having the direction for rendering the shadow.

12. The user interface as defined in claim 11, further comprising an actuatable icon on the menu as one said menu item and representing a shadow length for the rendered shadow that when actuated actuates the rendered shadow having the shadow length.

13. The user interface as defined in claim 11, wherein the menu item is a numerical expression.

14. The user interface as defined in claim 13, wherein the numerical expression is selected from the group consisting of degrees and radians.

15. The user interface as defined in claim 13, wherein the menu item is a compass point direction.

16. The user interface as defined in claim 13, wherein the actuation of the actuatable icon is actuated by a pointing device manipulating a point on the menu.

17. The user interface as defined in claim 16, wherein:
the point is on the rendering of the predetermined object; and
the pointing device manipulates the point by a point, click, and drag operation.

18. A method for displaying a rendering of a shadow, the method comprising:
serving a user interface for display as a menu;
displaying a rendering of a predetermined object upon the menu;
displaying an actuatable icon as a menu item on the menu, the icon representing a selection of a shadow direction for the predetermined object; and
upon the actuation of said menu item by said selection, rendering a shadow having the appearance of being cast from the rendered object in the selected shadow direction.

19. The method as defined in claim 18, further comprising:
displaying a second actuatable icon on the menu as a second menu item representing a selectable shadow length for the rendered shadow; and
upon the actuation of said second actuatable icon, rendering the shadow having the selected shadow length.

20. The method as defined in claim 18, wherein the menu item is a numerical expression.

21. The method as defined in claim 20, wherein the numerical expression is selected from the group consisting of degrees and radians.

22. The method as defined in claim 18, wherein the menu item is a compass point direction.

23. The method as defined in claim 18, further comprising a print actuation icon that when, actuated actuates a printing operation for printing characters in a file that are shadowed in the selected shadow direction.

24. The method as defined in claim 23, wherein a word processor software application actuates the display of the menu.

25. The method as defined in claim 23, wherein the printing operation is selected from the group consisting of printing, magnetic tape recording, photo imaging substrate recording, and magneto optical writing on to storage devices.

26. A computer-readable media containing computer-executable instructions that, when executed on a computer, performs the method as defined in claim 18.

27. A shadow rendering system comprising:
a display device;
a host computer in electrical communication with the display device and performing a demand print application program including the steps of:
serving a user interface for display as a menu on a screen of the display device in communication with a host computer;
rendering a display of a predetermined object on the menu;
displaying an actuatable icon as a menu item on the menu, the icon representing a selection of a shadow direction for the predetermined object; and
upon the actuation of said menu item:
executing an application program on the host computer to calculate a rendering of a shadow having the appearance of being cast from the rendered predetermined object in the selected shadow direction; and
displaying the calculated shadow rendering as being cast from the rendered predetermined object in the selected shadow direction.

28. The system as defined in claim 27, wherein:
the shadow rendered by the application program executing on the host computer has a default length; and
the demand print application program further includes the steps of:
displaying a second actuatable icon on the menu as a second menu item representing a selectable shadow length for the rendered shadow; and
upon the actuation of said second menu item, said application program executing on the host computer further performing the step of rendering the shadow having the selected shadow length.

29. The system as defined in claim 27, wherein the menu item on the menu is a numerical expression.

30. The system as defined in claim 29, wherein the numerical expression is selected from the group consisting of degrees and radians.

31. The system as defined in claim 27, wherein the menu item is a compass point direction.

32. The system as defined in claim 27, wherein:
the host computer is in electrical communication with a printing device; and
the demand print application program includes the steps of:
displaying an actuatable print icon as a menu item on the menu; and
upon the actuation of the actuatable print icon, the demand print application program executes a printing operation upon the printing device that prints shadowed objects having the selected shadow direction.

33. The system as defined in claim 32, wherein the printing device is selected from the group consisting of a printer, a magnetic tape recorder, a photo imaging substrate recorder, and a magneto optical writer.
